(19) United States
(12) Patent Application Publication
(10) Pub. No.: US 2025/0235765 A1
(43) Pub. Date: Jul. 24, 2025

(54) MANUFACTURING METHOD AND STRUCTURE OF COMPOSITE MATERIAL RACKET FRAMES

(71) Applicant: ALAN LIN, TAICHUNG CITY (TW)

(72) Inventor: ALAN LIN, TAICHUNG CITY (TW)

(21) Appl. No.: 18/825,147

(22) Filed: Sep. 5, 2024

(30) Foreign Application Priority Data
Jan. 24, 2024 (TW) 113102667

(51) Int. Cl. A63B 60/54; A63B 49/10; A63B 59/42; B29C 70/48; B29K 105/08; B29K 307/04; B29K 309/08; B29K 621/00; B29K 623/00; B29K 633/00; B29K 675/00; B29L 31/52

(52) U.S. Cl. CPC A63B 60/54; A63B 49/10; A63B 59/42; B29C 70/48; A63B 2209/02; B29K 2105/08; B29K 2307/04; B29K 2309/08; B29K 2621/003; B29K 2623/12; B29K 2633/26; B29K 2675/00; B29K 2715/003; B29L 2031/5245

(57) ABSTRACT

A manufacturing method and structure for a composite material racket frame includes the following steps:
(a) Resin impregnation: Impregnate a composite material with resin;
(b) Wrapping the core mold with composite material: Use a core mold in the shape of a racket, made of polymethacrylimide (PMI) or expanded polypropylene (EPP) material; then wrap the composite material around the core mold to form a composite material layer. The mutually wrapped composite material layers and core mold together form a semi-finished product;
(c) Heating and pressurizing: Place the semi-finished product into a mold with a cavity, and heat the mold to a preset temperature. After heating, the core mold expands due to heat, forming internal pressure within the semi-finished product;
(d) Cooling and curing: Stop heating and allow the semi-finished product to cool until it reaches a cured state, and
(e) Finished product formation: Remove a finished racket frame from the mold.

### FIELD OF THE INVENTION

The present invention relates to a manufacturing method and structure of a composite material racket frame, particularly a manufacturing method and structure that can be applied to various rackets such as netted or non-netted rackets, aiming to achieve light weight, excellent control, and shock absorption.

### BACKGROUND OF THE INVENTION

Common ball sports can be generally divided into those “using hitting tools” and those “not using hitting tools.” “Not using hitting tools” refers to sports where players directly use their hands, feet, or bodies to attack, receive, or pass the ball, such as basketball, volleyball, handball, soccer, American football, water polo, dodgeball, and bowling. “Using hitting tools” refers to sports where players use hitting tools to contact and play the ball, including baseball, tennis, badminton, hockey, pickleball, golf, croquet, table tennis, billiards, etc.

Common hitting tools, such as rackets, bats, shafts, and mallets, generally have a racket-like, bat-like, or rod-like shape. Their shapes and structures vary according to the specific requirements of different sports movements and game rules, and they must comply with the game regulations. Especially since most ball sports are included in the Olympic Games, the equipment must also comply with the relevant Olympic regulations to be used.

Further analyzing the hitting equipment of the racket type, such as the hitting tools used in tennis, badminton, table tennis, and ping pong, their structure must have a racket face and a grip. When used, the grip is held by hand, and the racket face is used to hit the ball, so the racket face is the hitting part. The racket face can be further divided into a “plate body structure” and a “net structure.” For example, the racket faces of tennis rackets and badminton rackets belong to the “net structure,” which is a hollow frame enclosing a netted area, where a net is formed by weaving lines within the netted area as the hitting surface. The racket faces of table tennis and pickleball rackets belong to the “plate body structure,” which uses a plate-like part as the hitting surface.

For rackets with a solid plate body structure, carbon fiber is commonly used as the outer layer of the racket, while plastic materials are used for the inner layer. Further, based on various requirements such as frame strength, shock absorption, racket face rebound, and racket face support, different technical applications and variations are made in the racket structure, materials, and manufacturing process.

For example, in the racket face of a pickleball or table tennis racket, if the shock absorption effect is better, the impact force of the ball will be absorbed by the racket face, the rebound force when hitting out will be smaller, the rebound sensitivity will be lower, the strength and hardness of the racket face will be lower, and the feel when swinging the racket will be heavier, resulting in poor ball control. Conversely, when the shock absorption effect of the solid plate racket face is poorer, less impact force of the ball is absorbed by the racket face, the rebound force when hitting out is greater, the rebound sensitivity is higher, the strength and hardness of the racket face are higher, and the feel when swinging the racket is lighter and the ball control is better. Therefore, the structure and material of the racket face affect many physical factors, resulting in various rackets with different structures and materials, each with different characteristics, suitable for different users based on their preferences and physical conditions.

A conventional solid plate face structure is disclosed in Chinese patent CN114569990A, which is a “shock-absorbing pickleball racket.” Another conventional solid plate face pickleball racket frame structure is disclosed in Chinese patent CN115155026A, which is a “pickleball racket.” Yet another conventional solid plate face pickleball racket frame structure is disclosed in Chinese patent CN112870660A, which is a “multi-layer composite pickleball racket.” Among the aforementioned conventional solid plate face racket-related technologies, the first case is the manufacturing process of a pickleball racket, while the second and third cases are the structural technologies of a pickleball racket. Further analysis shows that the first and second cases are mainly technical contents developed to enhance shock absorption or vibration damping functions, using a rubber shock-absorbing layer with a multi-layer lamination structure on the racket face. The inner part of the racket face in the second and third cases has a honeycomb structure, which not only maintains the rigidity of the racket face but also the honeycomb structure has good durability and environmental resistance.

The aforementioned three cases of conventional technologies all use a multi-layer core layer structure to buffer the impact force of the pickleball and achieve a better shock absorption effect as the technical focus. However, because most of the pickleball's impact force is consumed, the player needs to exert more force to make the pickleball fly to the same distance. When the pickleball comes into contact with the racket face, the degree of depression of the racket face is large, resulting in a large friction force, making it more difficult to control the rebound and flying direction of the ball. Moreover, the honeycomb structure is easily affected by different rebound forces when touching different positions on the honeycomb frame or honeycomb hole. On the other hand, a large number of cushioning core layers will also increase the overall weight of the racket, causing a burden on the player's hands. Furthermore, for users with less swing force, such as children and the elderly, pickleball rackets with enhanced shock absorption effects are not suitable. In addition, the manufacturing cost of the conventional honeycomb core layer is quite high, and the manufacturing process is more complicated.

For rackets with netted faces, since the racket frame needs to provide support for string weaving and withstand the tension of the strings as well as the impact force when hitting the ball, the support and rigidity requirements of the frame are higher to avoid the racket from breaking. In order to achieve better frame support, conventional techniques such as multi-layer structures, metal tube layers, wooden inner tubes, or the use of expanding agents are applied within the racket frame.

Conventional techniques for rackets with netted faces, such as Taiwan patent No. 090101386, disclose a “racket manufacturing method combining a metal tube and a fiber material,” which has a composite material layer on the outer layer and a hollow metal frame on the inner layer. Another conventional racket structure with a netted face, as disclosed in Taiwan patent No. 100116656, has a composite material layer on the outer layer and a nylon inner tube and expanding agent on the inner layer. Yet another conventional racket structure with a netted face, disclosed in Taiwan patent No. 090211041, has a composite material layer on the outer layer, a wooden inner ring layer, and a fiber composite inner tube on the inner layer.

On the other hand, regarding the aforementioned conventional techniques for rackets with netted faces, in addition to the widespread use of carbon fiber materials on the outer layer, to maintain the support and rigidity of the racket frame, inner layers with multi-layer structures, metal tube layers, wooden inner tubes, or expanding agents are used as technical means. However, the more layers the racket frame has, the more complex the manufacturing process becomes, and the higher the manufacturing costs of materials, equipment, molds, and labor, etc. Moreover, more layers will also make the overall weight of the racket heavier, consuming more of the player's physical strength when swinging the racket, and making ball control more difficult.

The present invention intends to provide a manufacturing method and structure of a composite material racket frame, to eliminate the shortcomings mentioned above.

### SUMMARY OF THE INVENTION

The present invention relates to a manufacturing method and structure of the composite material racket frame, and comprise the following steps:
(a) Resin impregnation: Impregnate a composite material with resin;
(b) Wrapping the core mold with the composite material: Use a core mold in the shape of a racket, made of polymethacrylimide (PMI) or expanded polypropylene (EPP) particles; then wrap the composite material around the core mold to form a composite material layer. The mutually wrapped composite material layers and core mold together form a semi-finished product;
(c) Heating and pressurizing: Place the semi-finished product into a mold with a cavity, and heat the mold to a preset temperature. After heating, the core mold expands due to heat, forming internal pressure within the semi-finished product;
(d) Cooling and curing: Stop heating and allow the semi-finished product to cool until it reaches a cured state, and
(e) Finished product formation: Remove a finished racket frame from the mold.

The composite material racket frame manufactured by the method forms an integrated racket frame consisting of a core mold and a composite material layer from the inside out. This racket frame is lightweight while maintaining considerable strength and rigidity. The plate-like racket face has hitting elasticity and can achieve a shock-absorbing effect. At the same time, it can effectively reduce manufacturing costs and improve handling feel.

The main purpose of this invention is to provide a manufacturing method and structure for a composite material racket frame. The core mold uses polymethacrylimide (PMI) or expanded polypropylene (EPP) particles, which expand when heated during the heating step, simultaneously generating internal pressure that allows the semi-finished product to fully fill the mold cavity space. This eliminates the need for any pressurizing device, effectively reducing manufacturing costs, and the process is suitable for forming both plate-type rackets and strung rackets.

A secondary purpose of the present invention is to provide a manufacturing method and structure for a composite material racket frame that eliminates the honeycomb structure in the core mold. This removes the need for processing steps to form the honeycomb structure in the core mold, and due to its simple structure, it effectively simplifies the manufacturing process, thereby saving production costs.

Another purpose of the present invention is to provide a manufacturing method and structure for a composite material racket frame where the core mold uses polymethacrylimide (PMI) or expanded polypropylene (EPP) particles to replace the conventional elastic layer with a honeycomb structure. This can improve the support of the hitting part, providing higher hardness and rigidity. The racket face has better rebound elasticity, improving the control feel of the hitting direction while still maintaining shock-absorbing effects.

A further purpose of the present invention is to provide a manufacturing method and structure for a composite material racket frame that uses a core mold made of polymethacrylimide (PMI) or expanded polypropylene (EPP) particles as the base. Compared to multi-layered, multi-elastic layered, metal inner-layered, wooden inner-layered, or expanding agent-filled conventional inner layer structures, the overall racket weight is lighter. This effectively reduces the burden when swinging the racket, making it suitable for children or elderly users.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a manufacturing method flow chart of a preferred embodiment of the present invention;

FIG. 2 is a schematic diagram of step (b) wrapping the core mold in a preferred embodiment of the present invention;

FIG. 3 is a schematic diagram of the mold and heating device in a preferred embodiment of the present invention;

FIG. 4 is a perspective view of the racket frame in a preferred embodiment of the present invention;

FIG. 5 is a cross-sectional view of the finished racket frame product in a preferred embodiment of the present invention;

FIG. 6 is a schematic diagram of step (b) wrapping the core mold in the second embodiment of the present invention;

FIG. 7 is a cross-sectional view of the finished racket frame product in the second embodiment of the present invention;

FIG. 8 is a schematic diagram of step (b) wrapping the core mold in the third embodiment of the present invention;

FIG. 9 is a cross-sectional view of the finished racket frame product in the third embodiment of the present invention, and

FIG. 10 is a cross-sectional view of the finished racket frame product in the fourth embodiment of the present invention.

### DETAILED DESCRIPTION OF THE PREFERRED EMBODIMENT

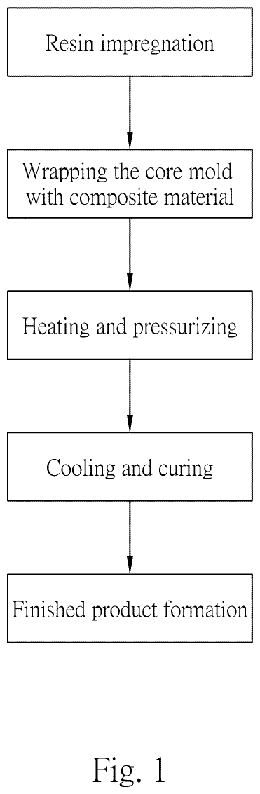

Referring to FIGS. 1 to 4, the manufacturing method for a composite material racket frame of the present invention comprises the following steps:
(a) Resin impregnation: Impregnate a composite material (30) with resin. The composite material (30) can be an application of one of the following materials: carbon fiber, glass fiber, or graphene.
(b) Wrapping the core mold with composite material: Use a core mold (10) in the shape of a racket, made of polymethacrylimide (PMI) or expanded polypropylene (EPP) material, then wrap the composite material (30) around the core mold (10) to form a composite material layer (30′). The mutually wrapped composite material layers (30′) and core mold (10) together form a semi-finished product (50). The core mold (10) has a hitting part (11) and a handle part (12). The core mold (10) can be in one of the following states: hollow, solid, or partially hollow. In this embodiment of the netted racket frame, the core mold (10) is solid. The hitting part (11) can be either in the form of a frame with a hollow middle or in the form of a solid plate. In this embodiment of the netted racket frame, the hitting part (11) is in the form of a frame with a hollow middle.
(c) Heating and pressurizing: Place the semi-finished product (50) into a mold (40) with a cavity (41), and heat the mold (40) to a preset temperature. After heating, the core mold (10) expands due to heat, forming internal pressure within the semi-finished product (50). Two heating devices (42) (43) are further used, placed on both sides of the mold (40) to conduct heating. The heating temperature exceeds the melting point temperature of the composite material (30). The heating temperature range is between 120° C. and 180° C.
(d) Cooling and curing: Stop heating and allow the semi-finished product (50) to cool until it reaches a cured state.
(e) Finished product formation: Remove a finished racket frame product (60) from the mold (40).

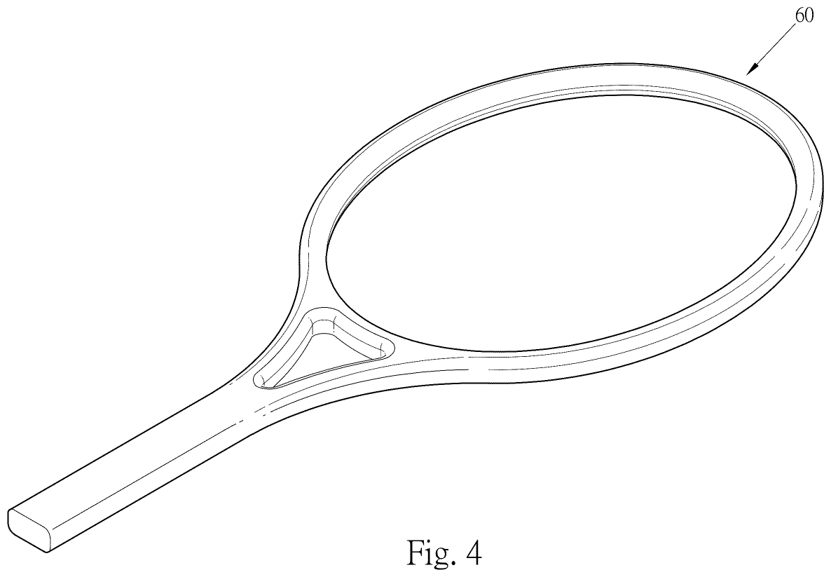

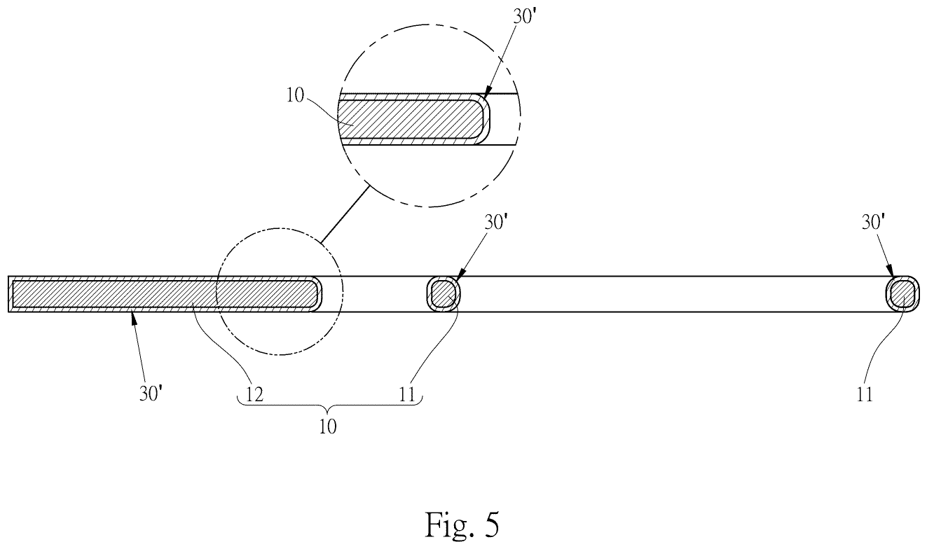

The structure of the finished racket frame product (60) manufactured according to the aforementioned method, as shown in FIGS. 4 and 5, and includes:

A core mold (10), made of polymethacrylimide (PMI) or expanded polypropylene (EPP) material, which integrally forms a hitting part (11) and a handle part (12). The hitting part (11) and handle part (12) can be molded as one piece. The core mold (10) is in one of the following states: hollow, solid, or partially hollow. In this embodiment of the netted racket frame, the core mold (10) is in the form of a frame with a hollow middle. The hitting part (11) is either in the form of a frame with a hollow middle or in the form of a solid plate. In this embodiment of the netted racket frame, the hitting part (11) is in the form of a frame with a hollow middle.

A composite material layer (30′), which simultaneously covers the core mold (10), forming an integrated racket frame comprising the hitting part and the handle part. The composite material layer (30′) can be an application of one of the following materials: carbon fiber, glass fiber, or graphene.

The structure of the composite material racket frame manufactured by the above method utilizes a core mold (10) made of polymethacrylimide (PMI) or expanded polypropylene (EPP) material, which is then completely wrapped with the composite material (30) to form an integrated racket frame. The interior of the hitting part (11) is made of polymethacrylimide (PMI) material, which has relatively high strength and rigidity. The racket face has better rebound elasticity, the overall racket weight is light, and the control feel is improved. Furthermore, it can reduce manufacturing costs, thus providing high economic benefits and practicality.

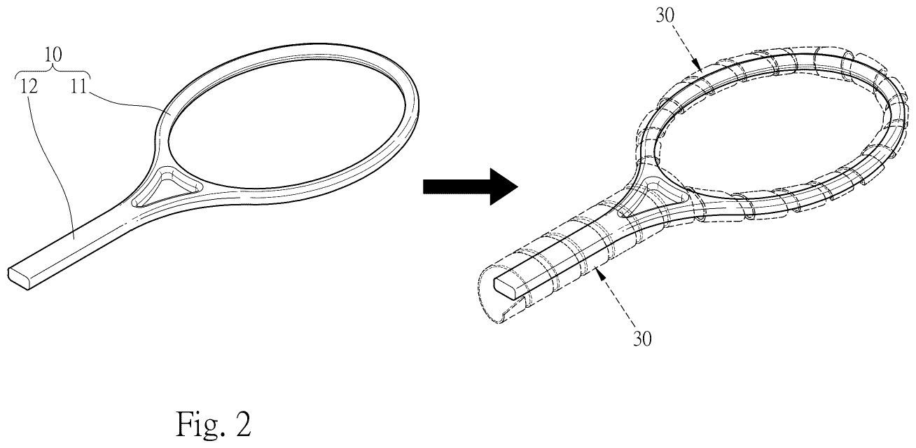

Referring to FIGS. 1 and 2, the manufacturing method of the present invention first involves step (a) resin impregnation, where a composite material (30) is impregnated with resin. The composite material (30) is one of the following materials: carbon fiber, glass fiber, or graphene. In step (b) wrapping the core mold with composite material, a core mold (10) made of polymethacrylimide (PMI) or expanded polypropylene (EPP) material in the shape of a racket is used. Then, the composite material (30) is wrapped around the core mold (10) to form a composite material layer (30′). This means that both the hitting part (11) and the handle part (12) are completely wrapped with the composite material (30), forming a semi-finished product (50).

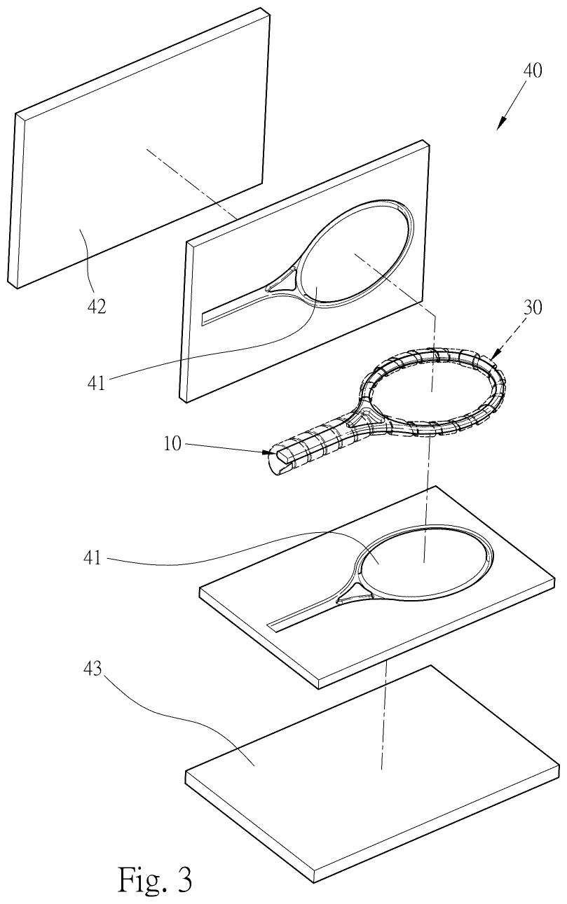

Referring to FIG. 3, in step (c) heating and pressurizing, the semi-finished product (50) is placed in the cavity (41) of the mold (40). After closing the mold, heating devices placed on both sides of the mold (40) begin to heat the mold. The heating temperature exceeds the melting point of the composite material, approximately 120° C. to 180° C. During heating, the core mold (10) expands due to heat, creating internal pressure within the semi-finished product (50), causing the semi-finished product (50) to fill the entire mold cavity. When the heating temperature exceeds the melting point of the composite material, the composite material layer (30′) softens and melts, completely covering the entire exterior of the semi-finished product (50).

In step (d) cooling and curing, after stopping the heating, the mold is first cooled to a preset temperature, allowing the semi-finished product (50) inside the mold to gradually solidify and take shape. Referring to FIG. 4, in step (e) finished product formation, a finished racket frame product (60) is removed from the mold (40).

Referring to FIGS. 4 and 5, the structure of the finished racket frame product (60) of the present invention, wherein in the hitting part (11), from inside to outside, there are the core mold (10) and the composite material layer (30′) in sequence. In the handle part (12), from inside to outside, there are the core mold (10) and the composite material layer (30′) in sequence.

The racket frame structure manufactured by the present invention goes through the five steps: (a) resin impregnation; (b) wrapping the core mold with composite material; (c) heating and pressurizing; (d) cooling and curing; and (e) finished product formation; forms an integrated racket frame consisting of a core mold (10) and a composite material layer (30′) from the inside out. This can effectively achieve the following benefits:

1. In step (c) heating and pressurizing, because the core mold (10) is made of polymethacrylimide (PMI) or expanded polypropylene (EPP) material, it gradually expands when heated, generating internal pressure. This causes the semi-finished product (50) to completely fill the mold cavity (41) space, eliminating the need for any pressurizing or filling-related equipment, thus effectively reducing manufacturing costs.

2. This embodiment uses polymethacrylimide (PMI) or expanded polypropylene (EPP) material as the core mold (10), replacing conventional inner layer structures commonly used in netted rackets such as metal layers, wooden layers, or expanding agents. This results in fewer frame layers and a simplified manufacturing process.

3. By using polymethacrylimide (PMI) or expanded polypropylene (EPP) material as the core mold (10) instead of conventional inner layer structures commonly used in strung rackets such as metal layers, wooden layers, or expanding agents, the process is simplified and the structure is simpler. Therefore, compared to conventional strung rackets, the present invention uses fewer materials, and the manufacturing costs for required preparation or use of equipment, molds, labor, etc., are lower.

4. The structure of netted racket of this embodiment, due to its fewer internal layers, can effectively reduce the overall weight of the racket. Additionally, by using polymethacrylimide (PMI) or expanded polypropylene (EPP) material, it maintains the necessary support and rigidity. This makes swinging the racket easier and less strenuous, while also improving ball control ability.

5. By using a core mold (10) made of polymethacrylimide (PMI) or expanded polypropylene (EPP) material as the base, which occupies a larger volume of the overall racket frame in the structural design, compared to conventional inner layer structures commonly used in netted rackets such as metal layers, wooden layers, or expanding agents, the overall racket weight is lighter. This effectively reduces the burden when swinging the racket, making it suitable for children or elderly users.

6. The core mold can be pre-formed integrally to include both the hitting part and the handle part, eliminating the need for assembly operations to connect the two, thus further simplifying the process.

7. The manufacturing method of the present invention can be applied to both solid-body rackets and strung rackets.

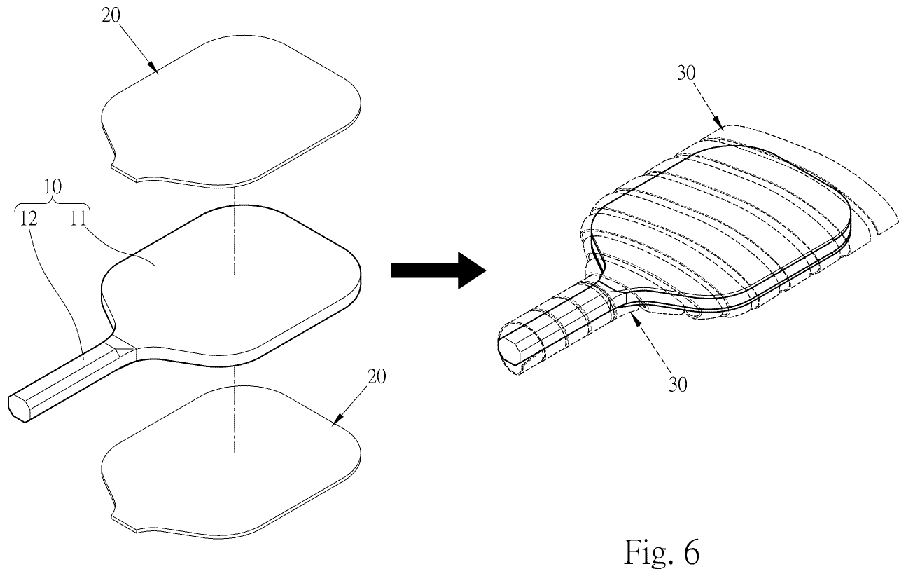

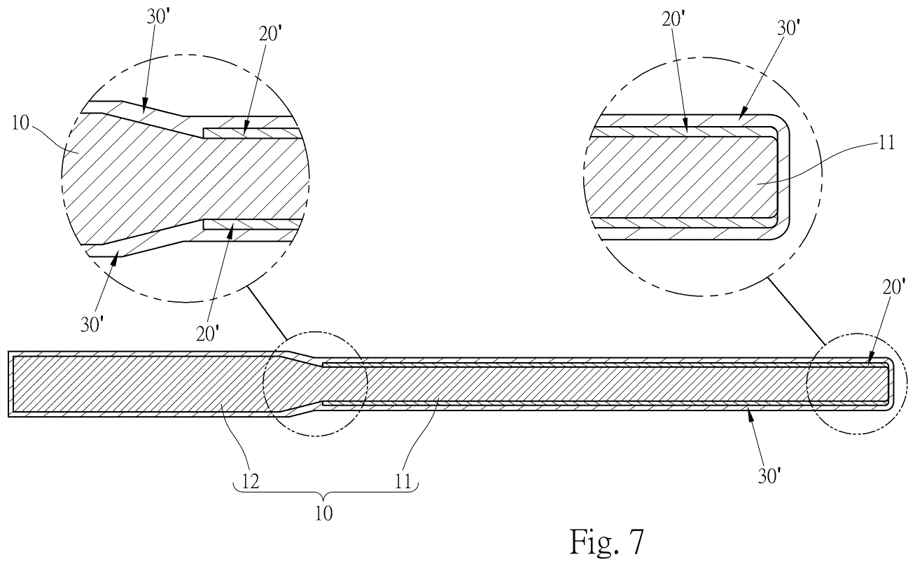

Referring to FIGS. 6 and 7, the second embodiment of the present invention is explained using a solid-body racket as an example. Its manufacturing method is the same as the first embodiment, consisting of five steps: (a) resin impregnation; (b) wrapping the core mold with composite material; (c) heating and pressurizing; (d) cooling and curing; (e) finished product formation. In step (b) wrapping the core mold with composite material, a core mold (10) made of polymethacrylimide (PMI) or expanded polypropylene (EPP) material in the shape of a solid-body racket is used. An elastomer (20) is applied to both sides of the hitting surface of the hitting part (11) to form an elastomer layer (20′), which can be fully or partially applied. The elastomer layer (20′) can be an application of one of the following plastic materials: TPR (thermoplastic rubber), TPU (Thermoplastic polyurethane), or TPE (thermoplastic elastomer). Then, the composite material (30) is wrapped around both the core mold and the elastomer layer (20′) to form a composite material layer (30′). This means that the hitting part (11) with the applied elastomer layer (20′) or the handle part (12) are completely wrapped with the composite material (30), forming a semi-finished product (50). This is followed by subsequent operations of (c) heating and pressurizing; (d) cooling and curing; and (e) finished product formation.

The structure of the finished racket frame product (60) in this embodiment includes: a core mold (10), made of polymethacrylimide (PMI) or expanded polypropylene (EPP) material, which integrally forms a hitting part (11) and a handle part (12), and the hitting part (11) of the core mold (10) is completely solid.

An elastomer layer (20′), which is an application of plastic material, is applied to both sides of the hitting surface of the hitting part.

A composite material layer, which simultaneously covers both the core mold and the elastomer layer, forming an integrated racket frame comprising the hitting part and the handle part.

In this embodiment, for the hitting part (11), from inside to outside, there are the core mold (10), the elastomer layer (20′), and the composite material layer (30′) in sequence. Similarly, for the handle part (12), from inside to outside, there are the core mold (10), the elastomer layer (20′), and the composite material layer (30′) in sequence.

The second embodiment of the present invention uses a core mold (10) made of polymethacrylimide (PMI) or expanded polypropylene (EPP) material, combined with the elastomer layer (20′) placed on the hitting surface of the hitting part (11), which is then completely wrapped with the composite material (30) to form an integrated racket frame. In addition to achieving a shock-absorbing effect with the elastomer layer (20′), the interior of the hitting part (11) made of polymethacrylimide (PMI) or expanded polypropylene (EPP) material, combined with the elastomer layer (20′), still maintains the strength and rigidity of the first embodiment.

The racket frame structure manufactured by the present invention goes through the five steps: (a) resin impregnation; (b) wrapping the core mold with composite material; (c) heating and pressurizing; (d) cooling and curing; and (e) finished product formation; forms an integrated racket frame consisting of a core mold (10) and a composite material layer (30′) from the inside out. This can effectively achieve the following benefits:

1. The core mold (10) is made of polymethacrylimide (PMI) or expanded polypropylene (EPP) material. It undergoes step (b) of wrapping with composite material in its original physical structural state, without the need for pre-processing the core mold (10) into a honeycomb structure. Compared to the known technology of using a honeycomb elastic layer for solid-body racket faces, this invention can effectively simplify the manufacturing process, thereby saving the processing and manufacturing costs associated with forming the honeycomb structure in the core mold.

2. Due to the material characteristics of polymethacrylimide (PMI) or expanded polypropylene (EPP), which provide better support and rigidity compared to other general plastic materials, the present invention's core mold (10) made of polymethacrylimide (PMI) or expanded polypropylene (EPP) replaces the conventional honeycomb structure elastic layer used in solid-body racket faces. In comparison, the tissue density of the core mold (10) is more compact. The rebound force across different areas of the hitting part (11) is more consistent after contact with a pickleball or table tennis ball. This solves the problem of varying rebound forces that occur when hitting different positions on the honeycomb frame or honeycomb cells in conventional structures.

3. The core mold (10), made of polymethacrylimide (PMI) or expanded polypropylene (EPP), replaces the conventional honeycomb structure elastic layer used in solid-body racket faces. In addition to the core mold (10) itself still having shock-absorbing effects, it also enhances the support of the hitting part, providing higher hardness and rigidity. The racket face has better rebound elasticity, improving the control feel of the hitting direction. This solves the problems associated with conventional designs where enhanced shock absorption leads to increased friction, making it more difficult to control the direction of the ball's rebound and flight.

4. By using a core mold (10) made of polymethacrylimide (PMI) or expanded polypropylene (EPP) material as the base, which occupies a larger volume of the overall racket frame in the structural design, compared to conventional solid-body racket faces with multi-layered elastic structures, the overall racket weight is lighter. This effectively reduces the burden when swinging the racket, making it suitable for children or elderly users.

Other aspects of this embodiment, including manufacturing methods, structures, assembly methods, technical applications, operational and usage states, and expected effects, are all identical to those described in the first embodiment.

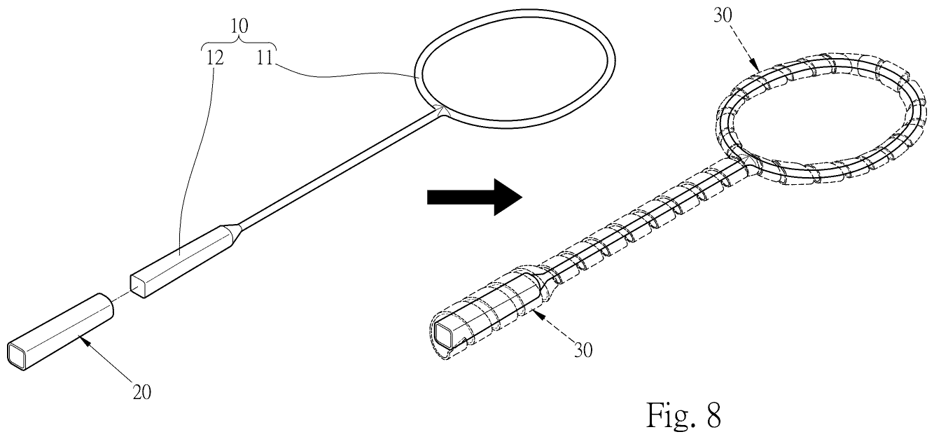

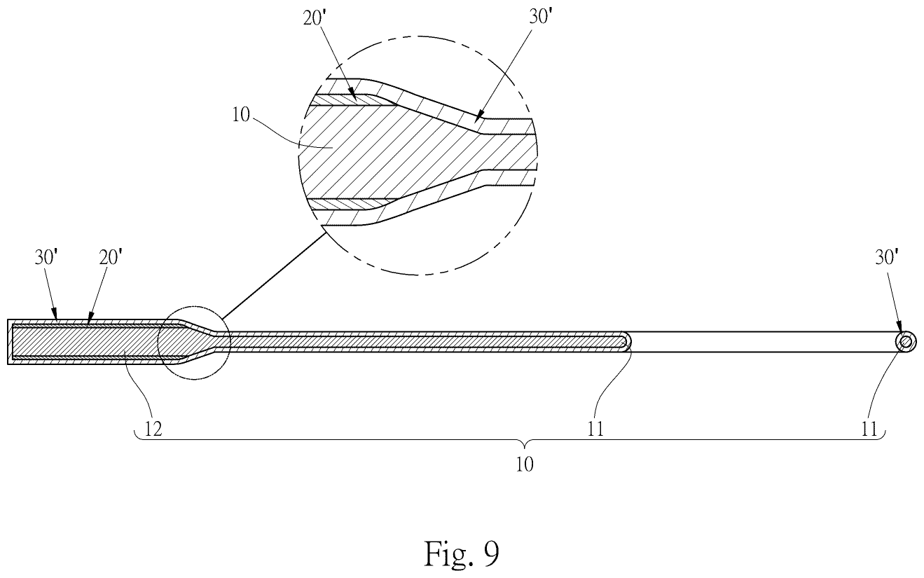

Referring to FIGS. 8 and 9, the third embodiment of the present invention is an implementation of a badminton racket with a netted face. In this embodiment, the hitting part (11) of the core mold (10) is in the form of a frame with a hollow middle. Before proceeding with step (b) of wrapping the core mold with composite material, an elastomer (20) can be pre-attached to the hitting part (11) or handle part (12) of the core mold (10), or the elastomer (20) can be applied to both the hitting part (11) and handle part (12) to form an elastomer layer (20′). Then, the composite material (30) is wrapped around both the core mold (10) and the elastomer layer (20′) to form a composite material layer (30′). The mutually wrapped composite material layer (30′), core mold (10), and elastomer layer (20′) together form a semi-finished product (50). This is followed by subsequent operations of (c) heating and pressurizing; (d) cooling and curing; and (e) finished product formation.

As shown in FIGS. 8 and 9, this embodiment uses an example where the elastomer (20) is partially applied to the handle part (12). Accordingly, in the hollow frame part of the hitting part (11), from inside to outside, there are the core mold (10) and the composite material layer (30′) in sequence. In the handle part (12), from inside to outside, there are the core mold (10), the elastomer layer (20′), and the composite material layer (30′) in sequence.

In this embodiment, because the handle part (12) is equipped with the elastomer layer (20′), when the impact force generated during ball hitting is transmitted to the handle part (12), it can effectively reduce vibration and shock, providing a better buffering effect. Other aspects of this embodiment, including manufacturing methods, structures, assembly methods, technical applications, operational and usage states, and expected effects, are all identical to those described in the first embodiment.

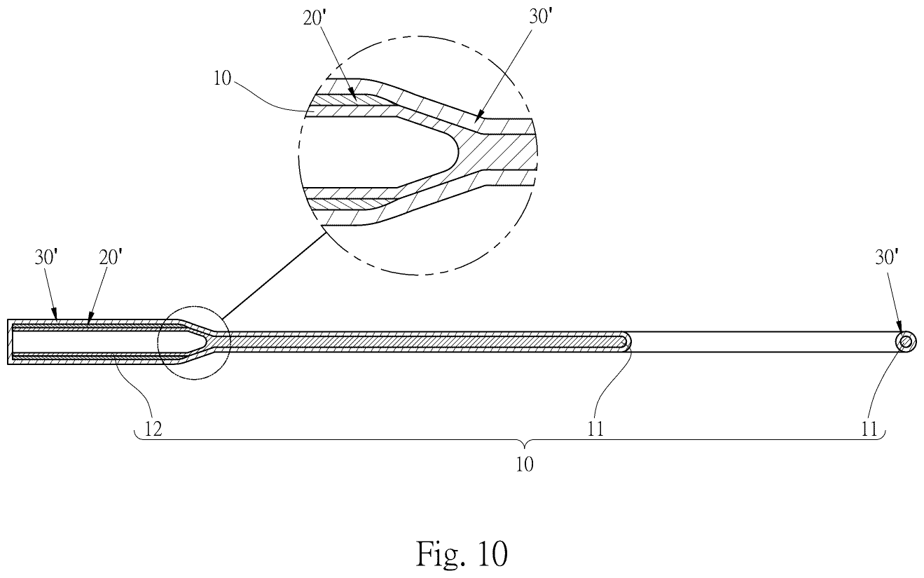

Referring to FIG. 10, the fourth embodiment of the present invention is an implementation of a partially hollow core mold. In this embodiment, before processing, the core mold (10) is pre-formed integrally with a solid hitting part (11) and a hollow handle part (12), before beginning the pickleball racket frame manufacturing method of the present invention. In the manufactured finished racket frame product (60), the handle part (12) is in a closed hollow state.

This embodiment mainly utilizes variations in the internal structure of the core mold (10). The hollow structure can make the overall racket weight lighter, and the volume of the hollow part can be adjusted as needed, allowing for the production of racket frames with different weights, thus achieving the effect of racket weight adjustment. On the other hand, in the pressurizing operation of step (c), the Resin Transfer Molding (RTM) technique can be further applied. Other aspects, including manufacturing methods, structures, assembly methods, technical applications, operational and usage states, and expected effects, are all identical to those described in the first embodiment.

In summary, the “Manufacturing Method and Structure of Composite Material Racket Frame” disclosed by the present invention is produced through the five steps: (a) resin impregnation; (b) wrapping the core mold with composite material; (c) heating and pressurizing; (d) cooling and curing; and (e) finished product formation. These steps create a racket frame structure that forms an integrated racket frame consisting of a core mold and a composite material layer from the inside out. The interior of the hitting part is made of polymethacrylimide (PMI) or expanded polypropylene (EPP) material, which provides relatively higher strength and rigidity. The racket face has better rebound elasticity, the overall racket weight is light, and the control feel is improved. It also reduces manufacturing costs. Additionally, the design can incorporate an elastomer layer to achieve shock-absorbing effects in the hitting part or handle part. The internal space of the core mold can be adjusted to modify the racket weight.

While we have shown and described the embodiment in accordance with the present invention, it should be clear to those skilled in the art that further embodiments may be made without departing from the scope of the present invention.

What is claimed is:

1. A manufacturing method for a composite material racket frame, comprising the following steps:
(a) Resin impregnation: impregnating a composite material (30) with resin;
(b) Wrapping a core mold (10) with composite material: using a core mold (10) in a shape of a racket; wrapping the composite material (30) around the core mold (10 to form a composite material layer (30′), the composite material layers (30′) and core mold (10) being mutually wrapped together to form a semi-finished product (50);
(c) Heating and pressurizing: placing the semi-finished product (50) into a mold (40) with a cavity (41), heating the mold (40) to a preset temperature and the core mold (10) expanding due to heat, forming internal pressure within the semi-finished product (50);
(d) Cooling and curing: stopping heating and the semi-finished product (50) being cooled until a cured state is reached, and
(e) Finished product formation: removing a finished racket frame product (60) from the mold (40).

2. The manufacturing method for a composite material racket frame as claimed in claim 1, wherein the core mold is made of a material selected from the group consisting of polymethacrylimide (PMI) material and expanded polypropylene (EPP) particles.

3. The manufacturing method for a composite material racket frame as claimed in claim 2, wherein the core mold (10) includes a hitting part (11) and a handle part (12), the core mold (10) is in one of the following states: hollow, solid, or partially hollow; the hitting part (11) is either in the form of a frame with a hollow middle or in the form of a solid plate.

4. The manufacturing method for a composite material racket frame as claimed in claim 2, wherein in step (c), two heating devices (42, 43) are placed on both sides of the mold (40) to conduct heating, the preset temperature in step (c) exceeds the melting point temperature of the composite material (30), the preset temperature range is between 120° C. and 180° C.

5. The manufacturing method for a composite material racket frame as claimed in claim 2, wherein in step (b), an elastomer (20) is placed on at least one predetermined position on the outside of the core mold (10) to form an elastomer layer (20′), then wrapping the composite material (30) around both the core mold (10) and the elastomer layer (20′) to form the composite material layer (30′).

6. The manufacturing method for a composite material racket frame as claimed in claim 5, wherein the core mold (10) includes a hitting part (11) and a handle part (12), the elastomer (20) is placed on either side of a hitting surface of the hitting part (11), or the elastomer (20) is applied to cover the handle part (12).

7. The manufacturing method for a composite material racket frame as claimed in claim 5, wherein the elastomer (20) is an application of plastic material, which is one of the following plastic materials: TPR (thermoplastic rubber), TPU (Thermoplastic polyurethane), or TPE (thermoplastic elastomer).

8. The manufacturing method for a composite material racket frame as claimed in claim 2, wherein the composite material (30) is an application of one of the following materials: carbon fiber, glass fiber, or graphene.

9. The manufacturing method for a composite material racket frame as claimed in claim 2, wherein in step (c), the Resin Transfer Molding (RTM) technique is applied.

10. A structure of a composite material racket frame, comprising:
a core mold (10), made of polymethacrylimide (PMI) material, integrally forming a hitting part (11) and a handle part (12), and
a composite material layer (30′) covering both the core mold (10) and an elastomer layer (20′), forming an integrated racket frame comprising the hitting part (11) and the handle part (12).

11. The structure of a composite material racket frame as claimed in claim 10, wherein the core mold is made of a material selected from the group consisting of polymethacrylimide (PMI) material and expanded polypropylene (EPP) particles.

12. The structure of a composite material racket frame as claimed in claim 11, wherein the core mold (10) is in one of the following states: hollow, solid, or partially hollow, the hitting part (11) is either in the form of a frame with a hollow middle or in the form of a solid plate.

13. The structure of a composite material racket frame as claimed in claim 11, wherein a thickness of the core mold (10) is greatest at the hitting part (11) on the opposite side of the handle part (12), and gradually decreases towards the handle part (12).

14. The structure of a composite material racket frame as claimed in 11, wherein an elastomer layer (20′) which is an application of plastic material, and is applied to either side of the hitting surface of the hitting part (11), or the elastomer layer (20′) can be applied to cover the handle part (12).

15. The structure of a composite material racket frame as claimed in claim 14, wherein the elastomer layer (20′) is an application of plastic material, which is one of the following plastic materials: TPR (thermoplastic rubber), TPU (Thermoplastic polyurethane), or TPE (thermoplastic elastomer), the composite material layer (30′ is an application of one of the following materials: carbon fiber, glass fiber, or graphene.
